(19) United States
(12) Patent Application Publication
(10) Pub. No.: US 2012/0079688 A1
(43) Pub. Date: Apr. 5, 2012

(54) While Being Worn, Magnetically Attaching A Man's Dress Shirt To His Undershirt

(76) Inventor: Philip Bunting, Portland, OR (US)

(21) Appl. No.: 12/897,196

(22) Filed: Oct. 4, 2010

(51) Int. Cl. H01F 7/02; F16B 47/00

(52) U.S. Cl. 24/303

(57) ABSTRACT

A magnetic clamp for attaching, while being worn, a man's dress shirt to his undershirt where the inside of the dress shirt is adjacent to the outside of the undershirt and a first magnetic device having first and a second surfaces is located on the outside of the dress shirt. A high friction material located on the second surface prevents the dress shirt from moving relative to the first magnetic device. A second magnetic device having a first and second surfaces is located on the inside of the undershirt and is aligned with the first magnetic device where a material having high friction is located on the first surface of the second magnetic device to prevent the undershirt from moving relative to the second magnetic device and the second magnetic device is oriented to be attracted by the first magnetic device to urge the undershirt into tight contact with the dress shirt.

### BACKGROUND OF THE INVENTION

1. Field of the Invention

The present invention relates generally to a man's clothing and more specifically to at least one convenient easy to use magnetic device located on a lower side of a man's dress shirt below his belt and another magnetic device which cooperates with the first magnetic device located on a lower side of his undergarment for securing the dress shirt to the undergarment while in use. A user of the present invention can use the magnetic device to both maintain his dress shirt in place and by folding the fabric of the dress shirt prior to securing the device, it can also serve to slender the fit of the shirt and prevent the shirt from having a sloppy, blousing look.

2. Description of Related Art

Numerous magnetic fasteners that include a magnet and a magnetic element are known in the prior art. More specifically, by way of example, U.S. Pat. No. 7,373,696 to Schoening discloses a device for holding neckties. The device comprises a magnet and a faceplate where the magnet is positioned under a portion of the wearer's shirt while the faceplate is positioned on a portion of the wearer's necktie. The shirt and/or necktie may additionally include pockets for housing the magnet and/or faceplate. The faceplate may be decorative, and interchangeable, for prominent display in front of the necktie. Alternatively, the device may be configured to be completely hidden from view.

U.S. Pat. No. 7,065,841 to Sjoquist discloses a magnetic fastener for fastening a first flap of material to a second flap of material. A magnet is attached to one of the flaps while a magnetic element is attached to the other flap. A button, is attached to the first flap and interconnected to either the magnet or the magnetic element for allowing the magnetic fastener to be easily opened and closed.

U.S. Pat. No. 6,748,602 to Barnes discloses a magnetic collar stay used on sports shirts. The magnetic portions of the device are arranged so that the top portion and bottom portion of the device have opposite polarities from each other.

U.S. Pat. No. 6,505,385 to Grunberger discloses a magnetic closure for items of clothing having a female member and a male member with magnets. The female element has guiding means for coupling to the male element and the male element has mechanical engagement elements.

U.S. Pat. No. 6,434,801 to Grunberger discloses a magnetic closure for items of clothing having a magnetic body in a seat which is closed hermetically and is formed by two plates which are coupled at least in a region which surrounds the magnetic body.

U.S. Pat. No. 6,216,275 to Lee discloses a necktie with an anchoring member secured to the rear surface of the wide end of the necktie, an elastic member secured to center of the anchoring member, a small magnet secured to the end of the elastic member opposite that secured to the anchoring member, and a hook extending from the magnet. The elastic member is long enough to allow the magnet to engage a zipper, belt buckle or other metallic fastening element of a clothing article, and allow the hook to removably engage fastening elements of clothing articles such as zippers, belt buckles and buttons.

U.S. Pat. No. 5,740,558 to Messman discloses a device for attaching flexible articles, such as clothing items having an edge. The device includes a flexible strip which includes an end with a sewable edge, and a second end having a fastening device. The device is sown to an edge of the flexible article, such as a pair of socks, allowing the user to temporarily join a pair of socks when they are not being worn.

U.S. Pat. No. 5,682,653 to Berglof discloses a magnetic fastening device having a permanent magnet and an elongate tubular sheath made of nonmagnetic material which encloses a magnetic attraction member. Two magnetic attraction members may be interconnected by a flexible hinge member which is integral with the sheaths of the members and formed from a length of shrink tubing.

U.S. Pat. No. 5,604,960 to Good discloses a system for joining two garments with magnets fixed to opposing surfaces of the garment. The magnets are laminates produced from a support layer to which is added an adhesive layer. One or more magnets are positioned on the adhesive layer to align and retain them in place. A cover is added over the magnets, and shaped to the magnet(s) to form the laminate.

U.S. Pat. No. 4,399,595 to Yoon discloses two strips of flexible, non-magnetic material having magnets incorporated in them with mechanical detent means for holding strips adjacent to each other.

U.S. Pat. No. 4,015,296 to Malick discloses an elastic stocking having a zipper which has two synthetic plastic material engaging portions and magnetic material closing means where the magnet is movable along the engaging portions for closing and opening the zipper.

### SUMMARY OF THE INVENTION

In an exemplary embodiment of the present invention, there is disclosed a magnetic clamp for attaching, while being worn, a man's dress shirt to his undershirt where the inside of the dress shirt is adjacent to the outside of the undershirt and a first magnetic device having a first surface and a second surface has its second surface located on the outside of the dress shirt. A material having high friction is located on the second surface of the first magnetic device to prevent the dress shirt from moving relative to the first magnetic device. A second magnetic device having a first and second surfaces is located on the inside of the undershirt and is aligned with the first magnetic device where a material having high friction is located on the first surface of the second magnetic device to prevent the undershirt from moving relative to the second magnetic device and the second magnetic device is oriented to be attracted by the first magnetic device to urge the undershirt into tight contact with the dress shirt to prevent the dress shirt from moving relative to the undershirt.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a view of a magnetic device located on the outside of a man's dress shirt when being worn with an undershirt where the magnetic device may be permanently attached to the shirt or removably attached to the shirt and held in place by a second magnetic device located on the other side of the shirt and an undershirt where the dress shirt and the under shirt are sandwiched between the two magnetic devices in accordance with the principles of the invention;

FIG. 2 is a front view of the magnetic device covered with a decorative fabric or leather;

FIG. 3 is a side view of the magnetic device covered on one side with a high friction material such as a rubberized fabric that prevents the magnetic device from sliding on the dress shirt or undershirt and covered on the other side with a decorative fabric or leather; and

FIG. 4 is a side view of a dress shirt and an undershirt located between and being pressed together by two magnetic devices to prevent relative movement between the two garments.

### DESCRIPTION OF THE PREFERRED EMBODIMENT

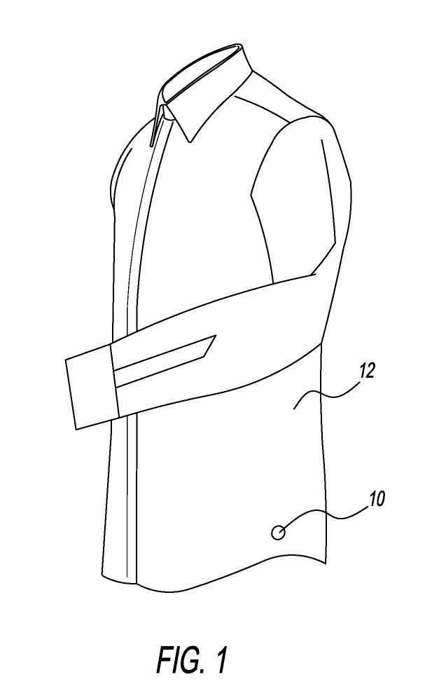

Referring to FIG. 1, there is disclosed a view of a magnetic device 10 located on the outside of a man's dress shirt 12 where the magnetic device may be permanently attached to the shirt or removably attached to the shirt and held in place by a second magnetic devise which may be removably or permanently attached to the other side of an undershirt which is positioned immediately behind the dress shirt where the dress shirt and the undershirt are sandwiched between the two magnetic devices in accordance with the principles of the invention.

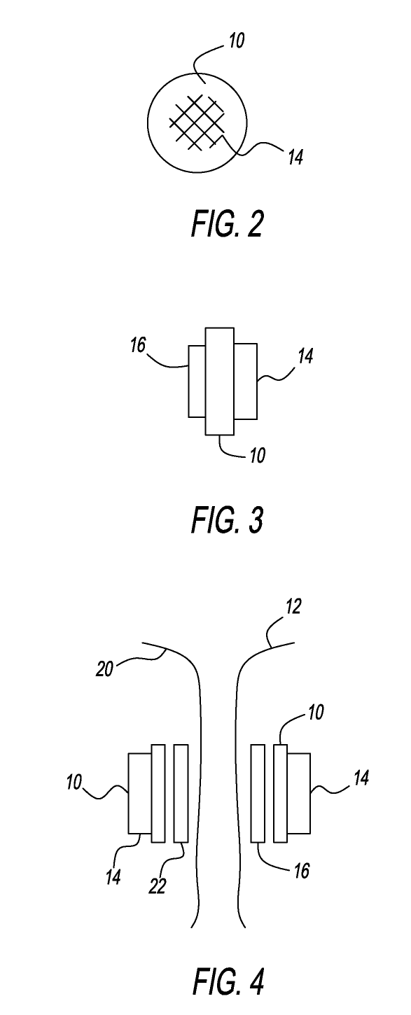

Referring to FIG. 2, there is disclosed a front view of the magnetic device 10 covered with a decorative fabric or leather. The magnetic device 10 which is located on the outside of a man's dress shirt may be covered with a decorative fabric or leather 14 and the magnetic device may have a diameter of between three-eighths of an inch and one inch, more or less and a thickness of between one-sixteenth of an inch and five-eighths of an inch more or less. It is understood that the shape of the magnetic device is not limited to a circular shape but may have another shape such as a square, a rectangular, an oblong, or any other shape which is desired. The front of the magnetic device can be covered with a decorative fabric, a logo, a painted figure, a fabric that has the same color, weave, pattern, look and feel as the dress shirt to which it is to be attached, a leather covering or any other covering. The covering can be attached to the magnetic device with a waterproof adhesive such as an epoxy adhesive and the edge of the cover may extend over the edge of the magnetic device to give the magnetic device a finished look.

Referring to FIG. 3, there is shown a side view of the magnetic device 10 covered on its front side with a decorative fabric or leather aesthetics, and can also be the same high friction material that is on the back side 14 and on its back side with a high friction material 16 such as a rubberized fabric that helps to prevent the magnetic device from slipping or moving relative to the dress shirt.

In use, pairs of magnetic devices are used to hold a man's dress shirt to his undershirt while being worn where one magnetic device of a pair is placed on the outside of the dress shirt below the man's belt and on each side of the dress shirt, and the second magnetic device of the pair is placed directly opposite each of the first magnetic device on the backside or inside of the undershirt, and the dress shirt and the undershirt are sandwiched between the pairs of magnetic devices. The second magnetic device which is located on the back side of a man's undershirt may be covered with a decorative fabric or leather and may have a diameter of between three-eighths of an inch and one inch, more or less and a thickness of between one-sixteenth of an inch and five-eighths of an inch more or less. It is understood that the shape of the second magnetic device is not limited to a circular shape but may have another shape such as a square, a rectangular, an oblong, or any other shape which is desired. The front of the second magnetic device can be covered with a decorative fabric, a logo, a painted figure, a fabric that has the same color, look and feel as the dress shirt, a leather covering or any other covering. The covering can be attached to the second magnetic device with a waterproof adhesive such as an epoxy adhesive and the edge of the cover may extend over the edge of the magnetic device to give the magnetic device a finished look.

The rear surface of the first magnetic device is located on the front of the dress shirt and is covered with a material having a high coefficient of friction such as a small sheet of rubber, a rubberized fabric, a release adhesive, etc.

In another embodiment of the invention the magnetic devices may be permanently attached to the dress shirt and/or the under shirt rather than being removably attached to either one or both of the two garments. In this embodiment the inside or back side of the magnetic device is not attached to a small sheet of rubber, a rubberized fabric, or a release adhesive. Instead, the inside of back side of the magnetic device is permanently attached to the garment with a waterproof adhesive such as an epoxy adhesive.

Referring to FIG. 4, there is shown a side view of a dress shirt 12 and an undershirt 20 located between and being pressed together by a first magnetic device 10 and a second magnetic device 22 which are removably attached to and prevent the dress shirt and the under shirt from moving relative to each other.

In an embodiment of the invention, the first magnetic device may be removably or permanently attached to a dress shirt while the second magnetic device may be removably attached to the undergarment.

In another embodiment of the invention the first magnetic device may be removably or permanently attached to a dress shirt while the second magnetic device may be permanently attached to the undergarment.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A magnetic clamp for preventing two movable articles of clothing from moving relative to each other while being worn comprising:
a man's dress shirt having an outside and an inside;
an undershirt having an outside and an inside wherein the outside of the undershirt is located next to the inside of the dress shirt;
a first magnetic device having a first surface and a second surface wherein the second surface is on the outside of the dress shirt;
a material having high friction is located on the second surface of the first magnetic device to prevent the dress shirt from moving relative to the first magnetic device;
a second magnetic device having a first surface and a second surface wherein the first surface is located on the inside of the undershirt and aligned with the first magnetic device; and
a material having high friction is located on the first surface of the second magnetic device to prevent the undershirt from moving relative to the second magnetic device;
wherein the second magnetic device is oriented to be attracted by the first magnetic device to urge the undershirt into tight contact with the dress shirt to prevent the dress shirt from moving relative to the undershirt.

2. The magnetic clamp of claim 1 wherein the first magnetic device is removably attached to the dress shirt and the second magnetic device is removably attached to the undershirt.

3. The magnetic clamp of claim 1 wherein the first magnetic device is permanently attached to the dress shirt and the second magnetic device is removably attached to the undershirt.

4. The magnetic clamp of claim 3 wherein the first magnetic device is permanently attached to the dress shirt with an adhesive.

5. The magnetic clamp of claim 4 wherein the adhesive is an epoxy.

6. The magnetic clamp of claim 1 wherein the first magnetic device is permanently attached to the dress shirt and the second magnetic device is permanently attached to the undershirt.

7. The magnetic clamp of claim 3 wherein the first magnetic device is permanently attached to the dress shirt with an adhesive and the second magnetic device is permanently attached to the undershirt with an adhesive.

8. The magnetic clamp of claim 4 wherein the adhesive is an epoxy.

9. The magnetic clamp of claim 1 wherein the material having high friction on the first or second surface of the first magnetic device is a rubberized fabric.

10. The magnetic clamp of claim 1 wherein a material having a weave, color or pattern or a high friction is located on the first surface of the first magnetic device.

11. The magnetic clamp of claim 10 wherein the material has a weave, color or pattern which is similar to that of the dress shirt.

12. The magnetic clamp of claim 10 wherein a material having a weave, color or pattern or a high friction is located on the second surface of the second magnetic device.

13. The magnetic clamp of claim 12 wherein the material has a weave, color or pattern which is similar to that on the first magnetic device.

14. The magnetic clamp of claim 12 wherein the material has a weave, color or pattern which is different than that on the first magnetic device.

15. The magnetic clamp of claim 1 wherein a piece of leather or a material having a high friction is located on the first surface of the first magnetic device.

16. The magnetic clamp of claim 1 wherein a piece of leather or a material having a high friction is located on the second surface of the second magnetic device.

17. The magnetic clamp of claim 1 wherein the first magnetic device is located on the man's dress shirt below the man's belt.

18. The magnetic clamp of claim 17 wherein one of the first magnetic device is located on a side of the dress shirt and another is located on the other side of the dress shirt.
